(19) United States
(12) Patent Application Publication
(10) Pub. No.: US 2006/0110195 A1
(43) Pub. Date: May 25, 2006

(54) Color image forming apparatus

(75) Inventors: Tomohiko Fuji, Yamatokooriyama-shi (JP); Susumu Murakami, Souraku-gun (JP); Hideaki Kadowaki, Souraku-gun (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/280,411

(22) Filed: Nov. 17, 2005

(30) Foreign Application Priority Data
Nov. 19, 2004 (JP) 2004-335499

(51) Int. Cl. G03G 21/12

(52) U.S. Cl. 399/360

(57) ABSTRACT

A color image forming apparatus includes: process printing units each having a photoreceptor drum; a transfer belt to which toner images are transferred; a transfer roller for transferring, as a whole, the toner images on the transfer belt to recording paper; a cleaning unit for collecting the remaining developers that have been left over on the photoreceptor drums and the transfer belt, is constructed such that a positioning sub-frame which is set with a developer collecting container for storing the collected developers and positions the process printing units relative to the housing, on one side of the apparatus body is removably attached to the housing.

This Nonprovisional application claims priority under 35 U.S.C. §119(a) on Patent Application No. 2004-335499 filed in Japan on 19 Nov. 2004, the entire contents of which are hereby incorporated by reference.

### BACKGROUND OF THE INVENTION

(1) Field of the Invention

The present invention relates to a color image forming apparatus and in particular relates to a color image forming apparatus, such as a copier, printer, facsimile machine or the like, which uses electrophotography as a process of image forming, wherein developer images formed on image bearing members are transferred to a printing medium.

(2) Description of the Prior Art

Recently, in the field of image forming apparatus, there is a common trend toward color configurations, and with the development of color image forming apparatus, an increased number of color image forming apparatus have become used.

In the field of color image forming apparatus, in order to make the apparatus compact and improve the speed of color printing, there have been proposed many kinds of color image forming apparatus using an indirect transfer process in which, by use of an intermediate transfer medium, color separations of image information developed by multiple process printing units are laid one over another on the intermediate transfer medium to form a lamination of developer images (primary transfer) and then the laminated developer images are transferred as a whole (secondary transfer) to recording paper that is conveyed, to thereby form a printed color image of information on the recording paper.

In order to create exact images, high-precision positioning is demanded for the multiple process printing units, intermediate transfer medium and the like of the color image forming apparatus. For this purpose, when the multiple process printing units, intermediate transfer member etc., are mounted to the apparatus body, these components are generally or in previous practice, positioned with reference to the front and rear frames of the apparatus body.

However, the color image forming apparatus includes such components as the intermediate transfer medium etc., which need maintenance at a fixed cycle and such components as developing units, which need replacement on demand because consumption of the developer from the developing unit in the color image forming apparatus differs depending on color.

Accordingly, in consideration of maintenance performance and workability, some measures have been contemplated such that the opening through which the developing units are attached is widened or the intermediate transfer medium and the developing units are constructed so that they can be positioned unit by unit relative to the apparatus frame. However, these manipulations exert influence on the strength of the apparatus frame and cause the problem of making the entire apparatus bulky due to increase in volume of each unit.

Under these circumstances, development of the positioning unit that positions and fixes the multiple process printing units, each including an image bearing member or photoreceptor drum, developing unit etc., as a whole by arranging an openable/closable front cabinet in the body frame of the color image forming apparatus, has been made.

Generally, in the color image forming apparatus using the indirect transfer process, a transfer efficiency as high as 100% cannot be achieved in the primary transfer step in which the developer image is transferred from the photoreceptor drum of the process printing unit to the intermediate transfer medium and in the secondary transfer step in which the developer image is transferred from the intermediate transfer medium to recording paper. Usually, the transfer efficiency in this process roughly falls within a range from 80 to 95%.

For this reason, in order for the developers that have not been transferred from the photoreceptor drums to the intermediate transfer medium and remain on the photoreceptor drums and the developer that has not been transferred from the intermediate transfer medium to recording paper and remains on the intermediate transfer medium, not to exert influence on the next printing operation and degrade the printing quality, various configurations which are adapted to collect the developers left over on the photoreceptor drums and intermediate transfer medium have been proposed (c.f. Patent literature 1: Japanese Patent Application Laid-open 2001-324905, Patent literature 2: Japanese Patent Application Laid-open 2002-14503).

Usually, in the color image forming apparatus using an intermediate transfer medium, waste developer is generated at five places, specifically, on the photoreceptor drums of four colors, yellow, magenta, cyan and black, and on the intermediate transfer medium after secondary transfer, so that cleaning devices are provided for those places so as to collect waste developer.

However, in conventional cleaning devices, the developer conveying paths for conveying the collected leftover developers and the developer collecting container for storage, tend to become bulky, hence this causes the problem of the whole apparatus becoming large-sized.

Further, it is also necessary to provide complicated waste developer conveying paths for collecting these together, which not only enlarges the apparatus and complicates the apparatus configuration but also may cause the problem of the developer scattering inside the machine.

### SUMMARY OF THE INVENTION

The present invention has been devised in view of the above conventional problems, it is therefore an object of the present invention to provide a color image forming apparatus which facilitates positioning of the process printing units and intermediate transfer medium and the like and which permits sharing of a developer collecting container for collection of waste developer, and is improved in work performance and maintenance performance in mounting the process printing units and the intermediate transfer medium.

In order to achieve the above object, the color image forming apparatus according to the present invention is configured as follows.

The color image forming apparatus according to the first aspect of the present invention, includes: a plurality of image forming units, each having an image bearing member for supporting a developer image formed with a developer corresponding to a color in accordance with color-separated image information that is obtained by separating image information into plural color components and subjecting them to image processes; an intermediate transfer medium to which a multiple number of developer images are transferred in layers; a transfer means for transferring the developer images that have been transferred in layers on the intermediate transfer medium, all at once, to a print medium; and a developer collecting section for collecting, at least, the remaining developers that have not been transferred from the image bearing members to the intermediate transfer medium but have been left over on the image bearing members and the remaining developer that has not been transferred from the intermediate transfer medium to the print medium but has been left over on the intermediate transfer medium, and is characterized in that a positioning member which is set with a developer collecting container for storing the collected developers and positions at least the plural image forming units relative to an apparatus frame, is removably attached to the apparatus frame on one side of the apparatus body.

The color image forming apparatus according to the second aspect of the present invention is characterized in that, in addition to the configuration described in the above first aspect, the developer collecting container is removably attached to the positioning member.

The color image forming apparatus according to the third aspect of the present invention is characterized in that, in addition to the configuration described in the above first and second aspects, the positioning member has a multiple number of positioning holes for positioning one end side of the plural image forming units with respect to the main scan direction, and the developer collecting container is disposed under the positioning holes.

The color image forming apparatus according to the fourth aspect of the present invention is characterized in that, in addition to the configuration described in the above first to third aspects, the developer collecting section includes screws for conveying and/or flattening the leftover developers collected from the multiple image forming units and the intermediate transfer medium, and the positioning member is formed with screw engagement holes that engage the screws.

The color image forming apparatus according to the fifth aspect of the present invention is characterized in that, in addition to the configuration described in the above fourth aspect, developer passages for guiding the developers that have been conveyed to the screw holes into the developer collecting container are formed extending from the screw holes to the developer collecting container, in the positioning member.

The color image forming apparatus according to the sixth aspect of the present invention is characterized in that, in addition to the configuration described in the above first to fifth aspects, the positioning member is constructed so as to pivot on one side edge relative to the apparatus body and will open and close with the other side edge rotated outwards of the apparatus body.

According to the first to sixth aspects of the invention, in a color image forming apparatus comprising: a plurality of image forming units, each having an image bearing member for supporting a developer image formed with a developer corresponding to a color in accordance with color-separated image information that is obtained by separating image information into plural color components and subjecting them to image processes; an intermediate transfer medium to which a multiple number of developer images are transferred in layers; a transfer means for transferring the developer images that have been transferred in layers on the intermediate transfer medium, all at once, to a print medium; and a developer collecting section for collecting, at least, the remaining developers that have not been transferred from the image bearing members to the intermediate transfer medium but have been left over on the image bearing members and the remaining developer that has not been transferred from the intermediate transfer medium to the print medium but has been left over on the intermediate transfer medium, a positioning member which positions at least the plural image forming units relative to an apparatus frame, is arranged on one side of the apparatus body. This configuration therefore makes positioning of the process printing units and the intermediate transfer medium easy and also makes the positioning member provide the function of reinforcement of the apparatus frame so as to increase the rigidity of the apparatus frame.

Since the arrangement of the developer collecting container in the positioning member makes it possible to put the leftover developers (waste developer) collected from the different process printing units and the intermediate transfer medium, together to one side, it is possible to use one common developer collecting container.

Further, removable attachment of the positioning member to the apparatus frame makes it possible to improve the workability and maintenance performance when the process printing units and the intermediate transfer medium are set in place.

In addition to the above common effects obtained from the first to sixth aspects of the invention, the following effects can be obtained from each aspect of the invention.

Detailedly, according to the second aspect of the present invention, removable attachment of the developer collecting container to the positioning member makes it possible for the operator to readily implement maintenance of the process printing units and intermediate transfer medium as well as readily perform replacement and maintenance of the developer collecting container, from one side of the apparatus body.

According to the third aspect of the invention, since the positioning member is formed with a multiple number of positioning holes for positioning one end side of the plural image forming units with respect to the main scan direction, it is possible to readily position the image forming units. Further, since the developer collecting container is disposed under these positioning holes, it is possible to simplify the structure of the conveyor passages of waste developer from the image forming unit's side toward the developer collecting container and the collected waste developer can be easily put together at one place.

According to the fourth aspect of the invention, since the developer collecting portion includes screws for conveying and/or flattening the leftover developers collected from the multiple image forming units and the intermediate transfer medium, this arrangement makes it possible to easily collect leftover developers to one side of the apparatus body. Further, since the positioning member is formed with screw engagement holes that engage the screws, it is possible to readily position the screws and facilitate secure engagement of the screws with the positioning member. As a result, it is possible to collect the thus conveyed waste developer into the developer collecting container without scattering the developer inside the machine.

According to the fifth aspect of the invention, since developer passages for guiding the developers that have been conveyed to the screw holes into the developer collecting container are formed extending from the screw holes to the developer collecting container, in the positioning member, collection of the collected leftover developers into the developer collecting container can be done by use of simple paths.

According to the sixth aspect of the invention, since the positioning member is constructed so as to pivot on one side edge relative to the apparatus body and will open and close with the other side edge rotated outwards from the apparatus body, this configuration makes it possible to facilitate the positioning member to open and close without separating it from the apparatus body, thus makes it easy to implement mounting and maintaining operations of the image forming units, intermediate transfer medium, developer collecting container and the like.

### BRIEF DESCRIPTION OF THE DRAWINGS

FIG. 1 is an illustrative view (sectional view from the rear) showing an overall configuration of a color image forming apparatus according to the embodiment of the present invention;

FIG. 2 is an illustrative view showing a configuration of a positioning sub-frame and a waste toner collecting container of the color image forming apparatus; and

FIG. 3 is a horizontal sectional view showing a state where the positioning sub-frame and the process printing units are positioned.

### DESCRIPTION OF THE PREFERRED EMBODIMENTS

The best mode for carrying out the present invention will hereinafter be described with reference to the drawings.

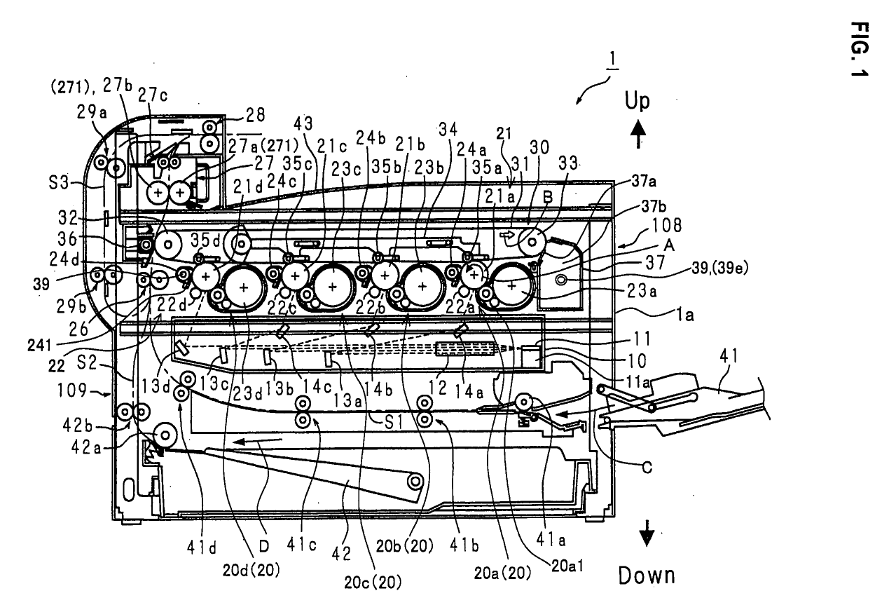

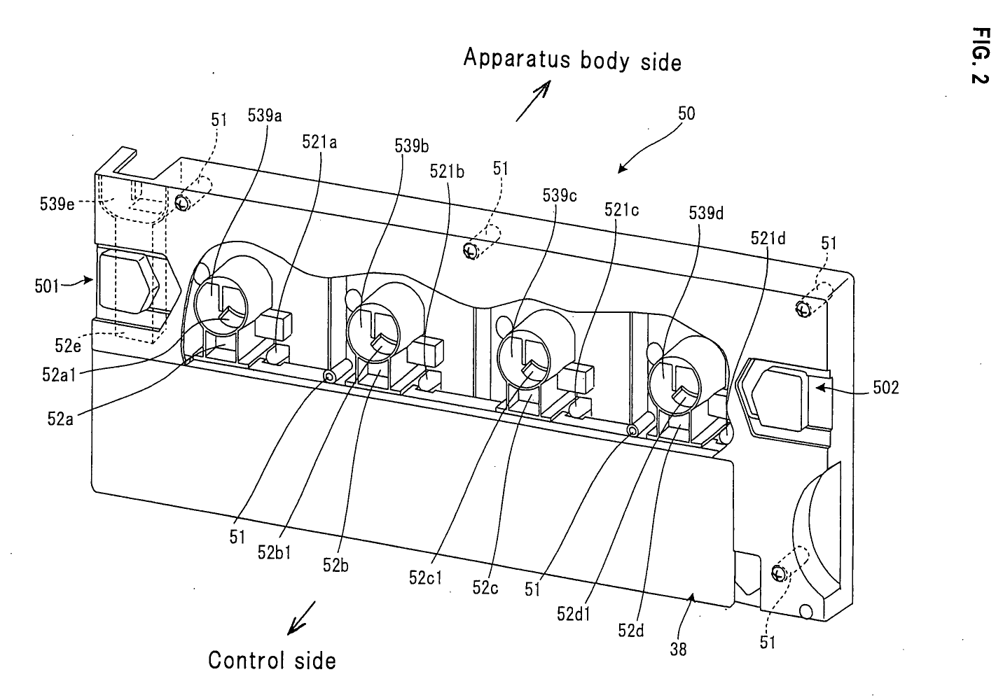

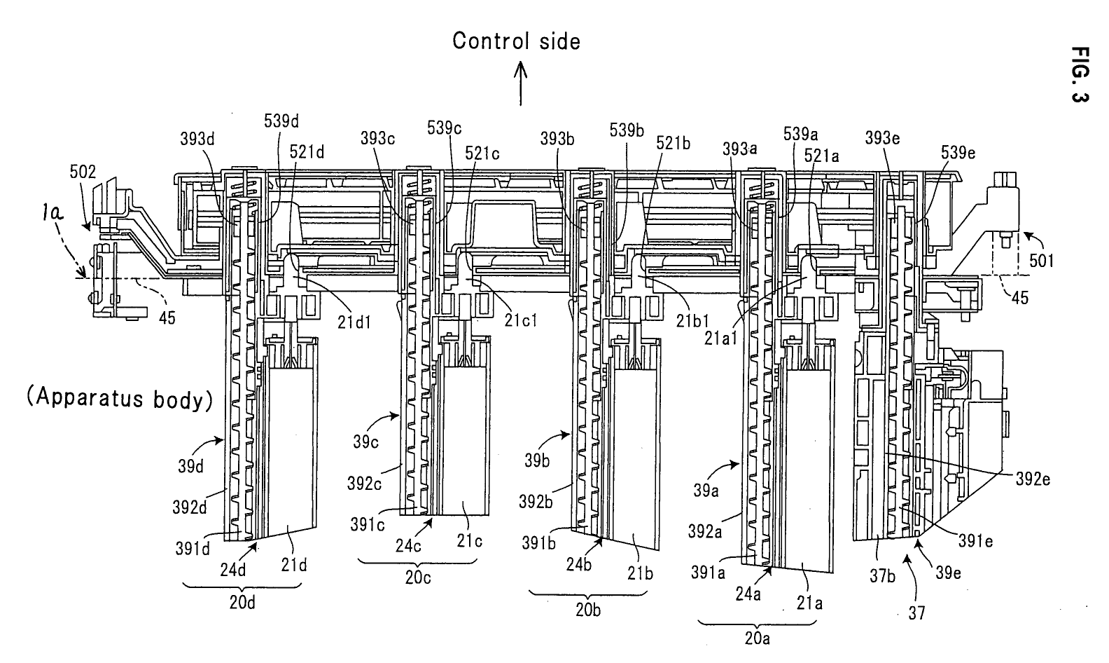

FIG. 1 shows one example of the present invention and is an illustrative view (sectional view from the rear) showing the overall configuration of a color image forming apparatus according to one embodiment of the present invention; FIG. 2 is an illustrative view showing a configuration of a positioning sub-frame and a waste toner collecting container of the color image forming apparatus; and FIG. 3 is a horizontal sectional view showing a state where the positioning sub-frame and the process printing units are positioned.

As shown in FIGS. 1 to 3, a color image forming apparatus 1 of the present embodiment includes: a plurality of image forming units or namely, process printing units 20 (20a, 20b, 20c and 20d) each having a photoreceptor drum 21 (21a, 21b, 21c or 21d) for supporting a developer image (which will be referred to as “toner image” hereinbelow) formed with a developer (which will be referred to as “toner” hereinbelow) corresponding to the color of color-separated image information; a transfer belt 31 or an intermediate transfer medium, to which a multiple number of toner images are transferred in layers; and a transfer roller 36 constituting a transfer means for transferring the toner images that have been transferred in layers on the transfer belt 31, all at once, to recording paper as a print medium; and photoreceptor cleaning units 24 and a transfer belt cleaning unit 37 constituting a developer collecting section for collecting the leftover toners (waste toner) that have not been transferred from photoreceptor drums 21 to transfer belt 31 and remain on the photoreceptor drums 21 and the leftover toner (waste toner) that has not been transferred from transfer belt 31 to recording paper and remains on transfer belt 31, and is characterized in that a positioning sub-frame 50 as to be a positioning member is arranged on one side of the apparatus body and removably attached to the apparatus frame, namely, housing 1a, and the positioning sub-frame is so constructed as to position the multiple process printing units 20 relative to the housing 1a and also enable a waste toner collecting container 38 for storing the collected waste toners as a whole, to fit therewith.

Here, concerning the positional relationship between the color image forming apparatus 1 of the embodiment and the operator, the operator is supposed to stand at the far side of the color image forming apparatus 1 shown in FIG. 1. In other words, the control side is located on the unillustrated side of color image forming apparatus 1, and the left and right sides of FIG. 1, as viewed, are the reverse of those when the operator faces the control side.

In the following description, the front side (F-side) refers to the operator side and the rear side (R-side) refers to the backside of color image forming apparatus 1, or the side shown by FIG. 1.

To begin with, the overall configuration of color image forming apparatus 1 will be described.

As shown in FIG. 1, color image forming apparatus 1 according to the present embodiment is a so-called digital color printer which is adapted to output a color image by separating color image information into images of individual colors, is mainly composed of an image forming portion 108 and a paper feed portion 109, and forms multi-color images or monochrome images on recording paper in accordance with a print job sent from an information processor (not illustrated) such as a personal computer etc., externally connected.

Image forming portion 108 forms multi-color images based on electrophotography with yellow (Y), magenta (M), cyan (C) and black (K) colors. This image forming portion is mainly composed of an exposure unit 10, process printing units 20 as image forming units, a fixing unit 27, a transfer belt unit 30 having a transfer belt 31 and a transfer belt cleaning unit 37 for cleaning transfer belt 31.

Describing the overall arrangement of image forming portion 108, fixing unit 27 is disposed on the top at one end side of housing 1a of color image forming apparatus 1, transfer belt unit 30 is extended under the fixing unit 27 from the one end side to the other end side of housing 1a, process printing units 20 are disposed under the transfer belt unit 30, and exposure unit 10 is disposed under the process printing units 20.

Further, transfer belt cleaning unit 37 is arranged on the other side end of transfer belt unit 30. Also, a paper output tray 43 is arranged contiguous to fixing unit 27, over image forming portion 108.

Paper feed portion 109 is arranged under the image forming portion 108.

In the present embodiment, as process printing units 20, four process printing units 20a, 20b, 20c and 20d, corresponding to individual colors, i.e., black (K), yellow (Y), magenta (M) and cyan (C), are arranged successively along transfer belt 31.

The process printing unit 20a for the color whose toner image, among all the toner images to be transferred to transfer belt 31, is transferred to transfer belt 31 first, or in other words, the process printing unit 20a which is located at a position most distant from transfer roller 36, holds a toner of black color so as to form a black toner image first on transfer belt 31.

These process printing units 20a, 20b, 20c and 20d are arranged in parallel to each other, in the approximately horizontal direction (in the left-to-right direction in the drawing) in housing 1a, and include respective photoreceptor drums 21a, 21b, 21c and 21d as the image bearing member for each individual associated color, respective charging devices 22a, 22b, 22c and 22d for charging the photoreceptor drums 21a, 21b, 21c and 21d, respective developing devices 23a, 23b, 23c and 23d and respective cleaning units 24a, 24b, 24c and 24d and other components.

Here, the symbol a, b, c, and d are added to the constituents so as to show correspondence to black (K), yellow (Y), magenta (M) and cyan (C), respectively. In the description hereinbelow, however, the constituents provided for each color are generally referred to as photoreceptor drum 21, charging device 22, developing device 23, and photoreceptor cleaning unit 24, except in the case where a constituent corresponding to a specific color needs to be specified.

Photoreceptor drum 21 is arranged so that part of its outer peripheral surface comes into contact with the surface of transfer belt 31 while charging device 22 as an electric field generator, developing device 23 and photoreceptor cleaning unit 24 are arranged along, and close to, the outer peripheral surface of the drum.

As charging device 22, a roller type charger is used and arranged, at a position on the approximately opposite side across photoreceptor drum 21, from transfer belt unit 30, and in contact with the outer peripheral surface of photoreceptor drum 21. Though in the present embodiment a roller type charger is used as charging device 22, a brush type charger, discharging type charger or the like may be used in place of the roller type charger.

Developing device 23 for each color holds a corresponding toner of black (K), yellow (Y), magenta (M) or cyan (C) color and is arranged on the downstream side of charging device 22 with respect to the rotational direction of the photoreceptor drum (in the direction of arrow A in the drawing), so that the toner of each color is supplied to the electrostatic latent image formed on the peripheral surface of the photoreceptor drum 21 to produce a visual image.

Photoreceptor cleaning unit 24 is arranged on the upstream side of charging device 22 with respect to the rotational direction of the photoreceptor drum. Photoreceptor cleaning unit 24 has a cleaning blade 241 and is configured so that the cleaning blade 241 is positioned in abutment with the outer peripheral surface of photoreceptor drum 21 so as to scrape and collect leftover toner off the photoreceptor drum 21. A reference numeral 39 in the drawing designates a screw for conveying collected toner.

Exposure unit 10 is to create an electrostatic latent image by radiating a laser beam onto the surface of every photoreceptor drum 21 of individual color in accordance with the image data for printing, and is mainly composed of a laser scanning unit (LSU) 11 having a laser illuminator 1a, a polygon mirror 12 and reflection mirrors 13a, 13b, 13c, 13d, 14a, 14b and 14c for reflecting the laser beam for individual colors.

The laser beam emitted from laser illuminator 11a is separated into components for different colors, by polygon mirror 12, so that the separated components of light are reflected by respective reflection mirrors 13a to 13d and 14a to 14c to illuminate the corresponding photoreceptor drums 21 of every color.

Here, concerning laser scanning unit 11, a writing head made up of an array of light emitting elements such as EL (electro luminescence), LED (light emitting diode) and others, may also be used instead of laser illuminator 11a.

Transfer belt unit 30 provides the function of forming a color toner image (multi-color toner image) on the transfer belt by successively transferring the toner images of different colors formed on photoreceptor drums 21 to the transfer belt 31, one over another.

Transfer belt unit 30 is mainly composed of transfer belt 31, a transfer belt drive roller 32, a transfer belt driven roller 33, a transfer belt tension mechanism 34 and intermediate transfer rollers 35a, 35b, 35c and 35d.

In the following description, any of the intermediate transfer rollers 35a, 35b, 35c and 35d will be referred to as intermediate transfer roller 35 when general mention is made.

Transfer belt 31 is formed of an endless film of about 75 μm to 120 μm thick. Transfer belt 31 is made from polyimide, polycarbonate or the like.

Also, transfer belt 31 is tensioned by transfer belt drive roller 32, transfer belt driven roller 33, transfer belt tension mechanism 34 and intermediate transfer rollers 35 so that its surface comes into contact with the outer peripheral surfaces of photoreceptor drums 21, and is adapted to move in the auxiliary scan direction (in the direction of arrow B in the drawing) by a driving force of the transfer belt drive roller 32.

Transfer belt drive roller 32 is disposed at one end side of housing 1a, and is wound with transfer belt 31 so as to drive the transfer belt 31 by applying a driving force whilst nipping and pressing the transfer belt 31 and a recording sheet together between itself and transfer roller 36 to convey the recording sheet.

Transfer belt driven roller 33 is disposed on the other end side of housing 1a, so as to suspend and tension the transfer belt 31 approximately horizontally from the one end side to the other end side of housing 1a, in cooperation with transfer belt drive roller 32.

Intermediate transfer rollers 35 are arranged in the interior space of transfer belt 31 wound between transfer belt drive roller 32 and transfer belt driven roller 33 so as to abut the inner surface of transfer belt 31 and press its outer peripheral surface against the outer peripheral surfaces of the photoreceptor drums 21.

Further, intermediate transfer roller 35 is formed of a metal (e.g., stainless steel) shaft having a diameter of 8 to 10 mm and a conductive elastic material such as EPDM, foamed urethane etc., coated on the outer peripheral surface of the metal shaft.

Each of the thus formed intermediate transfer rollers 35 is applied with a high-voltage transfer bias for transferring the toner image formed on photoreceptor drum 21 to transfer belt 31, i.e., a high voltage of a polarity (+) opposite to the polarity (−) of the electrostatic charge on the toner, so as to apply a uniform high voltage from the elastic material to transfer belt 31.

The visualized toner images (electrostatic images) formed on the photoreceptor drums 21 corresponding to every color are transferred one over another on transfer belt 31, reproducing the image information input to the apparatus. The thus formed laminated image information is transferred to recording paper by transfer roller 36 disposed at the contact point of transfer belt 31 with the paper.

Transfer roller 36 as a constituent of the transfer means is arranged opposing transfer belt drive roller 32 at approximately the same level and in parallel thereto and pressing against the transfer belt 31 wound on the transfer belt driver roller 32, forming a predetermined nip therewith while being applied with a high voltage of a polarity (+) opposite to the polarity (−) of the static charge on the toner, for transferring the multi-color toner image formed on the transfer belt 31 to the recording paper.

In order to produce a constant nip between transfer belt 31 and transfer roller 36, either transfer belt drive roller 32 or transfer roller 36 is formed of a hard material such as metal or the like while the other roller is formed of a soft material such as elastic rubber, foamed resin, etc.

A registration roller 26 is provided under transfer belt drive roller 32 and transfer roller 36. This registration roller 26 is configured so as to set the front end of a recording sheet fed from paper feed portion 109 in register with the leading end of the toner image on transfer belt 31 and deliver the sheet toward the transfer roller 36 side.

Since the toner adhering to transfer belt 31 as the belt comes in contact with photoreceptor drums 21, or the toner which has not been transferred to recording paper by transfer roller 36 and remains on transfer belt 31, would cause contamination of color toners at the next operation, it is removed and collected by transfer belt cleaning unit 37.

Transfer belt cleaning unit 37 includes: a cleaning blade 37a, as a cleaning element, located near transfer belt driven roller 33 and arranged so as to abut (come into sliding contact with) transfer belt 31; a box-like toner collector 37b for temporarily holding toner (waste toner), left over on and scraped from transfer belt 31 by the cleaning blade 37a; and a toner conveying device 39 of a screw type for sending waste toner from toner collector 37b to waste toner collecting container 38.

Also, transfer belt cleaning unit 37 is located near process printing unit 20a, on the upstream side of the process printing unit 20a with respect to the moving direction of transfer belt 31. Further, transfer belt 31 is supported from its interior side by transfer belt driven roller 33, at the portion where cleaning blade 37a comes into contact with the outer surface of transfer belt 31.

Fixing unit 27 includes: as shown in FIG. 1, paired fixing rollers 271 consisting of a heat roller 27a and a pressing roller 27b; and a conveying roller 27c above the fixing rollers 271. A recording sheet is input from below fixing rollers 271 and output to above conveying roller 27c.

A paper discharge roller 28 is arranged above fixing unit 27, so that the recording sheet conveyed from conveying roller 27c is discharged by the paper discharge roller 28 onto paper output tray 43.

Referring to the fixing of a toner image by fixing unit 27, a heating device (not shown) such as a heater lamp or the like, provided inside or close to heat roller 27a is controlled based on the detected value from a temperature detector (not shown) so as to keep the heat roller 27a at a predetermined temperature (fixing temperature) while the recording sheet with a toner image transferred thereon is heated and pressed between heat roller 27a and pressing roller 27b as it is being conveyed and rolled, so that the toner image is thermally fused onto the recording sheet.

A duplex printing paper path S3 for double-sided printing is constructed adjacent to fixing unit 27, from the rear of fixing unit 27 downward to the vicinity of paper feed portion 109. The recording sheet is inverted by conveying rollers 29a and 29b which are arranged at the top and bottom and along the duplex printing paper path S3, and delivered again toward transfer roller 36.

Specifically, conveying roller 29a is disposed at the rear of fixing unit 27 and conveying roller 29b is located below conveying roller 29a with respect to the top and bottom direction and at approximately the same level as registration roller 26.

Next, the configurations of positioning sub-frame 50 and waste toner collecting container 38 will be described in detail with reference to the drawings.

As shown in FIGS. 2 and 3, positioning sub-frame 50 has a transversally elongated box-like configuration in the side-to-side direction of image forming apparatus 1 and is disposed along the parallel arranged multiple process printing units 20 and transfer belt 31 and mounted to housing 1a from the far side (control side) of image forming apparatus 1, when viewed in FIG. 1.

This positioning sub-frame 50 has a pair of positioning structures 501 and 502 for positioning itself to housing la of the apparatus body, formed at both extremes, with respect to the side-to-side direction thereof. These positioning structures 501 and 502 provide a supporting function for easy handling when positioning sub-frame 50 is mounted to housing 1a.

Positioning sub-frame 50 is positioned to housing 1a, as shown in FIG. 3, to an attachment face 45 of housing 1a, by use of positioning structures 501 and 502. Specific measures for positioning can be done by providing projective positioning elements such as positioning pins, blocks, wedge-like fitting pieces etc., on the positioning sub-frame 50 side, forming engaging elements for receiving the positioning elements on the housing 1a side and mating one with the other so as to position them with respect to the vertical and horizontal directions.

Further, waste toner collecting container 38 having a box-shape elongated in the side-to-side direction of the apparatus is removably attached to the interior bottom of positioning sub-frame 50 (on its apparatus body side), as shown in FIG. 2.

Positioning sub-frame 50 has a multiple number of attachment bosses 51 for fixing itself to housing 1a with fasteners such as screws, bolts, etc., formed at the corners and along side edges thereof.

Positioning sub-frame 50 also has drum shaft bearing holes 521a to 521d formed at the positions opposing, respectively, the corresponding ends of attachment shafts 21a1 to 21d1 of photoreceptor drums 21a to 21d in process printing units 20a to 20d so as to support and engage these ends.

Positioning sub-frame 50 further has toner collecting ports 539a to 539e formed at the positions opposing, respectively, the corresponding ends of toner conveying devices 39a to 39d of process printing units 20a to 20d and toner conveying device 39e of transfer belt cleaning unit 37 so as to engage these ends.

At the bottom of toner collecting ports 539a to 539e, waster toner passages 52a to 52e that communicate with respective toner collecting ports 539a to 359e are formed with their lower ends opposing waste toner collecting container 38 located below. Reference numerals 52a l to 52e l designate openings of waste toner passages 52a to 52e, respectively.

In the above arrangement, photoreceptor drums 21a to 21d and toner conveying devices 39a to 39e are positioned to positioning sub-frame 50 by means of the aforementioned drum shaft bearing holes 521a to 521d and toner collecting ports 539a to 539d.

Each of toner conveying device 39a to 39e includes a cylindrical toner conveyor case 392a to 392e and a screw 391a to 391e having a continuous spiral vane formed on the outer periphery of its rotational axis, incorporated in cylindrical conveyor case 392a to 392e.

In this arrangement, as screw 391a to 391e is turned by an unillustrated driving source, the waste toner residing between the spiral vane of screw 391a to 391e and the interior wall surface of toner conveyor case 392a to 392e is moved in a direction away from photoreceptor drum 21a to 21d or toner collector 37b and brought toward positioning sub-frame 50 and fed into waste toner collecting container 38 arranged in the positioning sub-frame 50.

Of the aforementioned toner conveying devices 39a to 39e, for toner conveying devices 39a to 39d for photoreceptor cleaning units 24a to 24d, an unillustrated opening is formed in each toner conveyor case 392a to 392d so that waste toner scraped from photoreceptor drum 21a to 21d by cleaning blade 241 is input therethrough.

Also, for the conveying device 39e provided for transfer belt cleaning unit 37, an unillustrated opening is formed in toner conveyor case 392e so that waste toner once stored in toner collector 37b is input therethrough.

Each toner conveying device 39a to 39e is constructed so that it projects to the front side of color image forming apparatus 1 beyond the attachment face 45 of positioning sub-frame 50 in housing 1a. When positioning sub-frame 50 is mounted to color image forming apparatus 1, the sub-frame is positioned with each of the projected portions inserted through corresponding toner collecting port 539a to 539e into positioning sub-frame 50.

Further, in each of toner conveying devices 39a to 39e, a discharge hole 393a to 393e which communicates with waste toner passage 52a to 52e and allows waste toner to drop into waste toner collecting container 38, is formed on the bottom side of the projected portion of toner conveyor case 392a to 392e, which is inserted into toner collecting port 539a to 539e of positioning sub-frame 50.

In waste toner collecting container 38, openings (not shown) are formed at positions opposing waster toner passages 52a to 52e that are connected to toner collecting ports 539a to 539e of positioning sub-frame 50, so that waste toner can pass through these openings and be collected and stored in waste toner collecting container 38.

Next, the configuration of paper feed portion 109 will be described.

Paper feed portion 109 includes a manual feed tray 41 and a paper feed cassette 42 for holding recording sheets to be used for image forming, and is adapted to deliver recording sheets, one by one, from manual feed tray 41 or paper feed cassette 42 to image forming portion 108.

As shown in FIG. 1, manual feed tray 41 is arranged at one side end (on the right side in the drawing) of housing la of color image forming apparatus 1 so that it can be unfolded outside when used and folded up to the one end side when unused. This tray delivers paper, one by one, into the housing la of color image forming apparatus 1 when the user places a few recording sheets (necessary number of sheets) of a desired type.

Arranged on the downstream side with respect to the paper feed direction (the direction of arrow C in the drawing) of recording sheet by manual feed tray 41, inside housing la of color image forming apparatus 1, is a pickup roller 41a below exposure unit 10. Conveying rollers 41b, 41c and 41d are also disposed at approximately the same level along the path downstream with respect to the paper feed direction.

Pickup roller 41a touches one edge part of the surface of the recording sheet that is fed from manual feed tray 41 and reliably conveys the paper, sheet by sheet, by the function of the roller's frictional resistance.

Conveying roller 41d located on the most downstream side is positioned above conveying rollers 41b and 41c, so as to convey recording sheet upward.

The aforementioned pickup roller 41a and conveying rollers 41b, 41c and 41d constitute a recording paper conveying path S1.

On the other hand, paper feed cassette 42 is arranged under the image forming portion 108 and exposure unit 10 in housing 1a, so as to accommodate a large amount of recording sheets of a size specified by the specification of the apparatus or of a size that is determined beforehand by the user.

Arranged above one end side (the left-hand side in the drawing) of paper feed cassette 42 is a pickup roller 42a. A conveying roller 42b is also provided obliquely above and on the downstream side of the pickup roller 42a with respect to the recording paper feed direction (the direction of arrow D in the drawing).

Pickup roller 42a picks up one edge of the surface of the topmost recording sheet of a stack of recording paper on paper feed cassette 42 and reliably feeds the paper, sheet by sheet, by the function of roller's frictional resistance.

Conveying roller 42b conveys the recording sheet delivered from pickup roller 42a upward along a recording sheet feed path S2 formed on one end side inside housing la to image forming portion 108.

Next, image output by color image forming apparatus 1 in the present embodiment will be described.

Color image forming apparatus 1 is constructed so as to transfer the toner images formed on photoreceptor drums 21 to a recording sheet fed from paper feed portion 109 by a so-called intermediate transfer process, or via transfer belt unit 30.

First, charging device 22 uniformly electrifies the outer peripheral surface of photoreceptor drum 21 at a predetermined voltage.

The electrified photoreceptor drums 21 are irradiated with a laser beam from exposure unit 10, so that an electrostatic latent image for every color is formed on each color's photoreceptor drum 21.

Then, toner is supplied from developing device 23 to the outer peripheral surface of photoreceptor drum 21 so that the electrostatic latent image formed on the outer peripheral surface of photoreceptor drum 21 is visualized with toner (to be a toner image).

The toner images formed on photoreceptor drums 21 are transferred to transfer belt 31.

Transfer of the toner image from photoreceptor drum 21 to transfer belt 31 is done by intermediate transfer roller 35 arranged in contact with the interior side of transfer belt 31.

As intermediate transfer roller 35 is applied with a high voltage of a polarity (+) opposite to that of the polarity (−) of the electrostatic charge on the toner, transfer belt 31 has a high potential uniformly applied by the intermediate transfer roller 35, and presents the opposite polarity (+). By this arrangement, the toner image bearing negative (−) charge, on photoreceptor drum 21 is transferred to transfer belt 31 as the photoreceptor drum 21 turns and comes into contact with transfer belt 31.

The toner images of colors formed on respective photoreceptor drums 21 are transferred to transfer belt 31 as photoreceptor drums 21 turn and come into contact with the moving belt, and overlaid one over another, thus a color toner image is formed on transfer belt 31.

In this way, the toner images developed from electrostatic latent images on photoreceptor drums 21 for every color, are laminated on transfer belt 31 so that the image for printing is reproduced as a multi-color toner image on transfer belt 31.

Then, as transfer belt 31 moves and reaches the position where the recording sheet and the transfer belt 31 meet, the multi-color toner image on transfer belt 31 is transferred from transfer belt 31 to the recording sheet by the function of transfer roller 36.

Since the toner adhering to transfer belt 31 as the belt comes in contact with photoreceptor drums 21, or the toner which has not been transferred to the recording sheet by transfer roller 36 and remains on transfer belt 31, would cause color contamination of toners at the next operation, it is removed and collected by transfer belt cleaning unit 37.

Next, the operation of feeding recording paper by paper feed portion 109 will be described.

When recording paper placed on manual feed tray 41 is used, the recording paper is taken in by pickup roller 41a from manual feed tray 41, sheet by sheet, at controlled timings in accordance with the instructions from the control panel (not shown), and fed into the machine.

The recording sheet thus taken into the machine is conveyed along recording paper feed path S1 by conveying rollers 41b, 41c and 41d to image forming portion 108.

When the recording paper accommodated in paper feed cassette 42 is used, the paper is separated and fed from paper feed cassette 42, sheet by sheet, by pickup roller 42a, and conveyed by conveying roller 42b along recording paper feed path S2 to image forming portion 108.

The recording sheet conveyed from manual feed tray 41 or paper feed cassette 42 is delivered to the transfer roller 36 side, by registration roller 26, at such a timing as to bring the front end of the recording sheet in register with the leading end of the toner image on transfer belt 31, so that the toner image on transfer belt 31 is transferred to the recording sheet.

The recording sheet with a toner image formed thereon is further conveyed approximately vertically and reaches fixing unit 27, where the toner image is thermally fixed to the recording sheet by heat roller 27a and pressing roller 27b.

The recording sheet having passed through fixing unit 27, is discharged by discharge roller 28 when one-sided printing is selected, and placed face down on paper output tray 43.

In contrast, when double-sided printing is selected, the recording sheet is stopped and nipped by paper discharge roller 28, then the paper discharge roller 28 is rotated in reverse so that the recording sheet is guided to duplex printing paper path S3 and conveyed again to registration roller 26 by conveying rollers 29a and 29b.

By this movement, the printing face of the recording sheet is inverted and the direction of conveyance is reversed.

Illustratively, the leading edge of the sheet at the first printing is directed to the trailing end when the underside is to be printed, or the trailing edge of the sheet at the first printing is directed to the leading end when the underside is to be printed.

After the toner image is transferred and thermally fixed to the underside of the recording sheet, the sheet is discharged to paper output tray 43 by paper discharge roller 28.

Thus, the transfer operation to the recording sheet is done as described above.

Next, collection of the leftover toner that has not been transferred and remains on photoreceptor drums 21 and transfer belt 31 after the transfer process of color image forming apparatus 1 will be described.

To begin with, the toners that have not been transferred to transfer belt 31 and remain on photoreceptor drums 21a to 21d at the primary transfer in which the toner images from photoreceptor drums 21a to 21d are transferred to transfer belt 31 so as to form a laminated toner image, are scraped by cleaning blades 241 of photoreceptor cleaning units 24a to 24d and collected in photoreceptor cleaning units 24a to 24d.

The leftover toners collected in photoreceptor cleaning units 24a to 24d are conveyed and/or flattened as waste toner from photoreceptor cleaning units 24a to 24d to positioning sub-frame 50 by means of toner conveying devices 39a to 39d.

The waste toner arriving at positioning sub-frame 50, passing through toner collecting port 539a to 539d of positioning sub-frame 50, is collected into waste toner collecting container 38 located below.

On the other hand, the toner that has not been transferred to recording paper and has been left over on transfer belt 31 upon the secondary transfer where the toner images having transferred to transfer belt 31 are to be transferred together to recording paper, is scraped off by cleaning blade 37a of transfer belt cleaning unit 37 and collected into transfer belt cleaning unit 37.

The leftover toner collected in transfer belt cleaning unit 37 is conveyed and/or flattened as waste toner from transfer belt cleaning unit 37 to positioning sub-frame 50 by means of toner conveying device 39e.

The waste toner arriving at positioning sub-frame 50, passing through toner collecting port 539e of positioning sub-frame 50 and waster toner passage 52e, is collected into waste toner collecting container 38 located below.

In this way, the leftover toners remaining on photoreceptor drums 21a to 21d and transfer belt 31 are collected as a whole in waste toner collecting container 38 provided in positioning sub-frame 50.

When waste toner collecting container 38 has become full of waste toner, the front cover (not shown) is opened from the apparatus body so as to expose positioning sub-frame 50 with waste toner collecting container 38. Then, only the waste toner collecting container 38 is taken out from positioning sub-frame 50 so that the waster toner may be disposed of from waste toner collecting container 38 or the container may be replaced with a new empty waste toner collecting container 38.

According to the thus configured embodiment, since positioning sub-frame 50 is removably provided on one side (on the front side) of housing 1a that constitutes the apparatus frame of color image forming apparatus 1, it is possible to readily perform the positioning of photoreceptor drums 21a to 21d. Thus, this arrangement makes it possible to improve workability in the attachment work of process printing units 20a to 20d and the maintenance work of photoreceptor drums 21a to 21d.

Further, since positioning sub-frame 50 is formed in a box-shaped configuration, fixing of this positioning sub-frame 50 to housing 1a provides the function of reinforcement to improve the rigidity of housing 1a. As a result it is possible to assure reliable attachment of process printing units 20a to 20d, hence improve printing quality.

Moreover, according to the present embodiment, since waste toner collecting container 38 is arranged separately inside positioning sub-frame 50, or since the container is arranged not in the interior of the apparatus body but on one side of housing 1a of the apparatus body, it is possible to avoid contamination of the apparatus interior with waste toner. Further, since waste toner collecting container 38 can be easily attached and removed, it is possible to readily collect waster toner without getting the operator's hands dirty.

Still more, according to the present embodiment, since waste toner collecting container 38 is disposed under the toner collecting ports 539a to 539e formed in positioning sub-frame 50, it is possible to simplify the configuration of waste toner passages 52a to 52e for guiding waste toner from toner collecting ports 539a to 539e to waste toner collecting container 38 hence achieve easy collection of waste toner.

Though in this embodiment, positioning sub-frame 50 is removably fixed to housing 1a by fasteners, the present invention should not be limited to this attachment method of the positioning sub-frame. For example, positioning sub-frame 50 may be attached so that the sub-frame is able to pivot relative to the apparatus body at its bottom side and will open and close with the top side rotated outwards of the apparatus body.

This configuration makes it possible to cause positioning sub-frame 50 to open and close without separating it from the apparatus body, hence further facilitate mounting and maintenance work of process printing units 20, transfer belt 31 waste toner collecting container 38, etc.

Further, in the present embodiment, though positioning sub-frame 50 is constructed so as to position photoreceptor drums 21a to 21d and toner conveying devices 39a to 39e alone, the present invention should not be limited to this. For example, the components inclusive of transfer belt drive roller 32, transfer belt driven roller 33 etc., for moving transfer belt 31 wound therebetween, may be positioned altogether. This configuration makes it possible to simplify the attachment work and maintenance work of transfer belt 31.

The color image forming apparatus of the present invention should not be limited to the above embodiment and variational examples, but various changes and modifications can be made therein without departing from the spirit and scope of the invention.

What is claimed is:

1. A color image forming apparatus comprising:
a plurality of image forming units, each having an image bearing member for supporting a developer image formed with a developer corresponding to a color in accordance with color-separated image information that is obtained by separating image information into plural color components and subjecting them to image processes;
an intermediate transfer medium to which a multiple number of developer images are transferred in layers;
a transfer means for transferring the developer images that have been transferred in layers on the intermediate transfer medium, all at once, to a print medium; and
a developer collecting section for collecting, at least, the remaining developers that have not been transferred from the image bearing members to the intermediate transfer medium but have been left over on the image bearing members and the remaining developer that has not been transferred from the intermediate transfer medium to the print medium but has been left over on the intermediate transfer medium, characterized in that a positioning member which is set with a developer collecting container for storing the collected developers and positions at least the plural image forming units relative to an apparatus frame, is removably attached to the apparatus frame on one side of the apparatus body.

2. The color image forming apparatus according to claim 1, wherein the developer collecting container is removably attached to the positioning member.

3. The color image forming apparatus according to claim 1, wherein the positioning member has a multiple number of positioning holes for positioning one end side of the plural image forming units with respect to the main scan direction, and the developer collecting container is disposed under the positioning holes.

4. The color image forming apparatus according to claim 2, wherein the positioning member has a multiple number of positioning holes for positioning one end side of the plural image forming units with respect to the main scan direction, and the developer collecting container is disposed under the positioning holes.

5. The color image forming apparatus according to claim 1, wherein the developer collecting section includes screws for conveying and/or flattening the leftover developers collected from the multiple image forming units and the intermediate transfer medium, and the positioning member is formed with screw engagement holes that engage the screws.

6. The color image forming apparatus according to claim 2, wherein the developer collecting section includes screws for conveying and/or flattening the leftover developers collected from the multiple image forming units and the intermediate transfer medium, and the positioning member is formed with screw engagement holes that engage the screws.

7. The color image forming apparatus according to claim 3, wherein the developer collecting section includes screws for conveying and/or flattening the leftover developers collected from the multiple image forming units and the intermediate transfer medium, and the positioning member is formed with screw engagement holes that engage the screws.

8. The color image forming apparatus according to claim 4, wherein the developer collecting section includes screws for conveying and/or flattening the leftover developers collected from the multiple image forming units and the intermediate transfer medium, and the positioning member is formed with screw engagement holes that engage the screws.

9. The color image forming apparatus according to claim 5, wherein developer passages for guiding the developers that have been conveyed and/or flattened to the screw holes into the developer collecting container are formed extending from the screw holes to the developer collecting container, in the positioning member.

10. The color image forming apparatus according to claim 6, wherein developer passages for guiding the developers that have been conveyed and/or flattened to the screw holes into the developer collecting container are formed extending from the screw holes to the developer collecting container, in the positioning member.

11. The color image forming apparatus according to claim 7, wherein developer passages for guiding the developers that have been conveyed and/or flattened to the screw holes into the developer collecting container are formed extending from the screw holes to the developer collecting container, in the positioning member.

12. The color image forming apparatus according to claim 8, wherein developer passages for guiding the developers that have been conveyed and/or flattened to the screw holes into the developer collecting container are formed extending from the screw holes to the developer collecting container, in the positioning member.

13. The color image forming apparatus according to claim 1, wherein the positioning member is constructed so as to pivot on one side edge relative to the apparatus body and will open and close with the other side edge rotated outwards of the apparatus body.

14. The color image forming apparatus according to claim 2, wherein the positioning member is constructed so as to pivot on one side edge relative to the apparatus body and will open and close with the other side edge rotated outwards of the apparatus body.

15. The color image forming apparatus according to claim 3, wherein the positioning member is constructed so as to pivot on one side edge relative to the apparatus body and will open and close with the other side edge rotated outwards of the apparatus body.

16. The color image forming apparatus according to claim 4, wherein the positioning member is constructed so as to pivot on one side edge relative to the apparatus body and will open and close with the other side edge rotated outwards of the apparatus body.

17. The color image forming apparatus according to Claim 5, wherein the positioning member is constructed so as to pivot on one side edge relative to the apparatus body and will open and close with the other side edge rotated outwards of the apparatus body.

18. The color image forming apparatus according to claim 6, wherein the positioning member is constructed so as to pivot on one side edge relative to the apparatus body and will open and close with the other side edge rotated outwards of the apparatus body.

19. The color image forming apparatus according to claim 7, wherein the positioning member is constructed so as to pivot on one side edge relative to the apparatus body and will open and close with the other side edge rotated outwards of the apparatus body.

20. The color image forming apparatus according to claim 8, wherein the positioning member is constructed so as to pivot on one side edge relative to the apparatus body and will open and close with the other side edge rotated outwards of the apparatus body.

21. The color image forming apparatus according to claim 9, wherein the positioning member is constructed so as to pivot on one side edge relative to the apparatus body and will open and close with the other side edge rotated outwards of the apparatus body.

22. The color image forming apparatus according to claim 10, wherein the positioning member is constructed so as to pivot on one side edge relative to the apparatus body and will open and close with the other side edge rotated outwards of the apparatus body.

23. The color image forming apparatus according to claim 11, wherein the positioning member is constructed so as to pivot on one side edge relative to the apparatus body and will open and close with the other side edge rotated outwards of the apparatus body.

24. The color image forming apparatus according to claim 12, wherein the positioning member is constructed so as to pivot on one side edge relative to the apparatus body and will open and close with the other side edge rotated outwards of the apparatus body.
